(19) United States
(12) Patent Application Publication
(10) Pub. No.: US 2004/0017589 A1
(43) Pub. Date: Jan. 29, 2004

(54) Method for selecting a shading correcting line

(75) Inventor: Kuo-Jeng Wang, Kaohsiung City (TW)

Correspondence Address: LOWE HAUPTMAN GILMAN, & BERNER, LLP, 1700 Diagonal Road, Suite 310, Alexandria, VA, 22314, US

(73) Assignee: UMAX DATA SYSTEMS INC.

(21) Appl. No.: 10/206,198

(22) Filed: Jul. 29, 2002

(51) Int. Cl. H04N 1/40

(52) U.S. Cl. 358/461; 358/448

(57) ABSTRACT

A method for selecting a shading correcting line is provided. Scanning a white reference source to obtain several scan lines. Averaging brightness values of pixels from identical columns in the scan lines to obtain a new scan line composed of pixels having median brightness values. Adding one count in shading counting number when an absolute value of a difference of the median brightness values between each pair of adjacent pixels in the new scan line not less than a specification value of shading definition. Selecting the new scan line as a shading correcting line when total shading counting number less than a specification number of shading counts.

### BACKGROUND OF THE INVENTION

1. Field of the Invention

The present invention relates to a shading correction method for reducing non-uniformity in the density of a read image in an image reading apparatus such as a facsimile or an image scanner.

2. Description of the Prior Art

Conventional color image reading apparatuses generally scan an original placed on a transparent platen mainly composed of glass with light emitted from a light source and receive light reflected from the original to read an image on the original. For reading a color image, the image reading apparatus resolves the reflected light by some means into three components of light, i.e. R (red), G (green) and B (blue), and directs the three components on a light-receiving section of a photoelectric converter such as a CCD (charge-coupled device), which serves as a reading element, so as to convert them into analog electric signals of the three components R, G, and B. The signals are then outputted in the form of digital electric signals by means such as an A/D converter.

In the above-described image reading apparatus, there arises a phenomenon called shading distortion owing to various causes such as variations in quantity of light from the light source, variations in conversion characteristics of photoelectric conversion elements defining pixels, changes in quantity of light from the light source caused by changes of voltage in the device, changes in the conversion characteristics of the photoelectric conversion elements with time, and variations in quantity of light passing through a lens for forming images. The shading distortion means that the electric signals outputted by the photoelectric converter vary and do not represent a constant value even if an image of a consistent shade of color is taken by the image reading apparatus through optical scanning and directed to the photoelectric converter.

Various attempts have been made for the correction of the shading distortion to minimize variations in outputted signals and always obtain constant electric signals, regardless of the above-mentioned causes, when reading an image of the consistent shade. Such correction is called shading correction.

This shading correction is to be performed before reading an image of the original for correcting the light receiving data with use of white reference data obtained from the photoelectric conversion elements upon receiving reflected light from a white reference plate and black reference data obtained from the photoelectric conversion elements when the photoelectric conversion elements are shaded.

A generally employed method for shading correction is setting a reference white sheet for white balance in a place other than the original platen on a travel path of an optical system which optically scans and reads an image of the original. This reference white sheet is optically scanned and the image thereof is read by the photoelectric converter before the original is optically scanned. On the basis of data of this read image, correction values for the signals representative of the R, G and B components are calculated for every photoelectric conversion element defining a pixel. Data of the read original is corrected by adding the calculated correction values.

However, it is not always possible to perform an optimum shading correction as it is likely the case such as the reference white sheet is not in a mint condition or electrical noise maybe picked up, rendering to degrade reliability of the white reference data and the black reference data. This in turn results in disabling the proper shading correction.

Accordingly, it is an intention to provide a method of shading correction, which can improve shading correction operated on a read image based on good shading correction values, and thus obtaining an outputted image with a high degree of reliability.

### SUMMARY OF THE INVENTION

It is one objective of the present invention to provide a method for selecting a shading correcting line, which makes shading correction based on good shading correction values, thereby being capable of obtaining a good shading-corrected image.

It is another objective of the present invention to provide a method for selecting a shading correcting line, which makes it possible to enable image reading performed with a high degree of reliability.

It is a further objective of the present invention to provide a method for selecting a shading correcting line, which is capable of removing adverse effects due to impulse noise or dust that is accumulated on a white reference plate.

It is still a further objective of the present invention to provide a method for judging shading of an image, which can calculate an exact shading counting number of the image, and accordingly judging whether to utilize the image.

In order to achieve the above objectives of this invention, the present invention provides a method for selecting a shading correcting line. Scanning a white reference source to obtain a plurality of first scan lines of pixel brightness values. Generating a second scan line composed of median brightness values from the first scan lines, each median brightness value being an average of pixel brightness values from a common column of the first scan lines. Adding one count in shading counting number when an absolute value of a difference of median brightness values between each pair of adjacent pixels in the second scan line being not less than a specification value of shading definition. When total shading counting number is less than a specification number of shading counts, selecting the second scan line as a shading correcting line. In accordance with the present invention, a shading correction operation based on good shading correction values is implemented, and thereby being capable of obtaining a good shading-corrected image.

### BRIEF DESCRIPTION OF THE DRAWINGS

The objectives and features of the present invention as well as advantages thereof will become apparent from the following detailed description, considered in conjunction with the accompanying drawings.

FIG. 1 is a schematic diagram of a document feeder unit of an image reading apparatus;

FIGS. 2A and 2B is a flow chart of the present method according to one embodiment of the present invention; and

FIG. 3 schematically illustrates steps of selecting a shading correcting line in accordance with the principle of the present invention.

### DESCRIPTION OF THE EMBODIMENTS

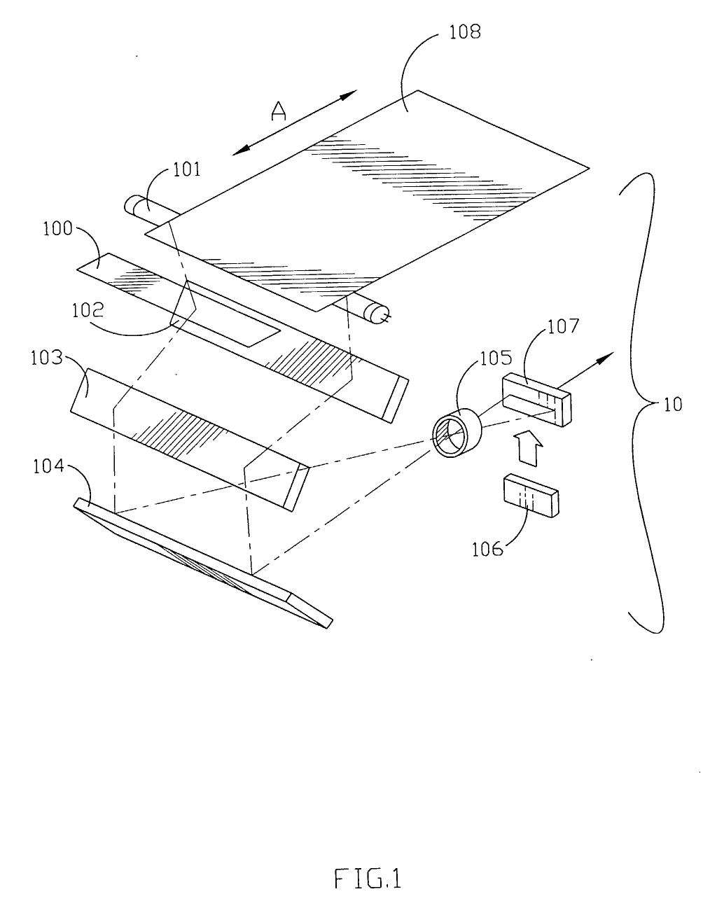

FIG. 1 is a schematic diagram of a document feeder unit 10 of an image reading apparatus used for illustrating the present method. The document feeder unit 10 includes a white reference plate 100, an exposure lamp 101, a lamp driving unit (not shown), an optical system including reflection mirrors 102-104 and a focus lens 105, a shading plate 106, a shading plate drive unit (not shown), a photoelectric linear sensor 107, and a transparent platen (not shown) on which a document 108 is placed.

The white reference plate 100 is used to obtain white reference data for use in a shading correction and is provided in an area next to the document 108 which is placed on the transparent platen, as shown in FIG. 1.

The exposure lamp 101 consists of a fluorescent lamp or a halogen lamp to emit light to the white reference plate 100 and the document 108. The lamp drive unit (not shown) is to illuminate the exposure lamp 101 and is to move the same along an arrow A (in FIG. 1) to illuminate the entire surface of the document 108 along the arrow A.

The optical system including reflection mirrors 102-104 and the focus lens 105 to lead the reflected light from the document 108 to the photoelectric linear sensor 107 to form an image on its light-receiving plane.

The shading plate 106 is to shade the light-receiving plane of the photoelectric linear sensor 107 to obtain black reference data for use in a shading correction.

The photoelectric linear sensor 107 can be a CCD (charge-coupled device) line sensor or a contact image sensor (CIS) to output analog voltage signals. And, an A/D converter (not shown) is to convert the analog voltage signals to 8 bit digital signals. This read image data of 8 bit digital signals is subjected to a shading correction operation based on shading correction values from a shading correcting line selected in accordance with the present method.

Alternately, the black reference data can be obtained by turning the exposure lamp 101 off to cause the photoelectric linear sensor 107 to perform a reading operation. In producing the black reference data, the exposure lamp 101 is turned off. In the state, reflected light from the white reference plate 100 is read. Since the white reference plate 100 is not illuminated, there is no reflected light from the white reference plate 100, whereby the photoelectric linear sensor 107 captures the black reference data.

The present method of selecting a shading line established by the white reference data or black reference data will be described in detail in accordance with one embodiment of the present invention.

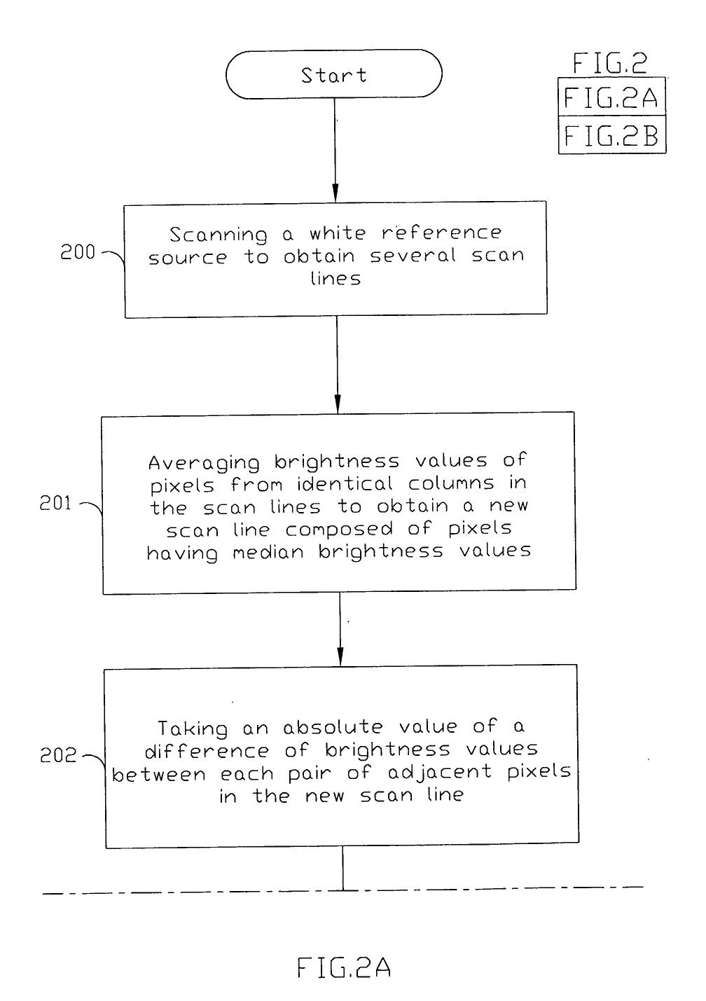

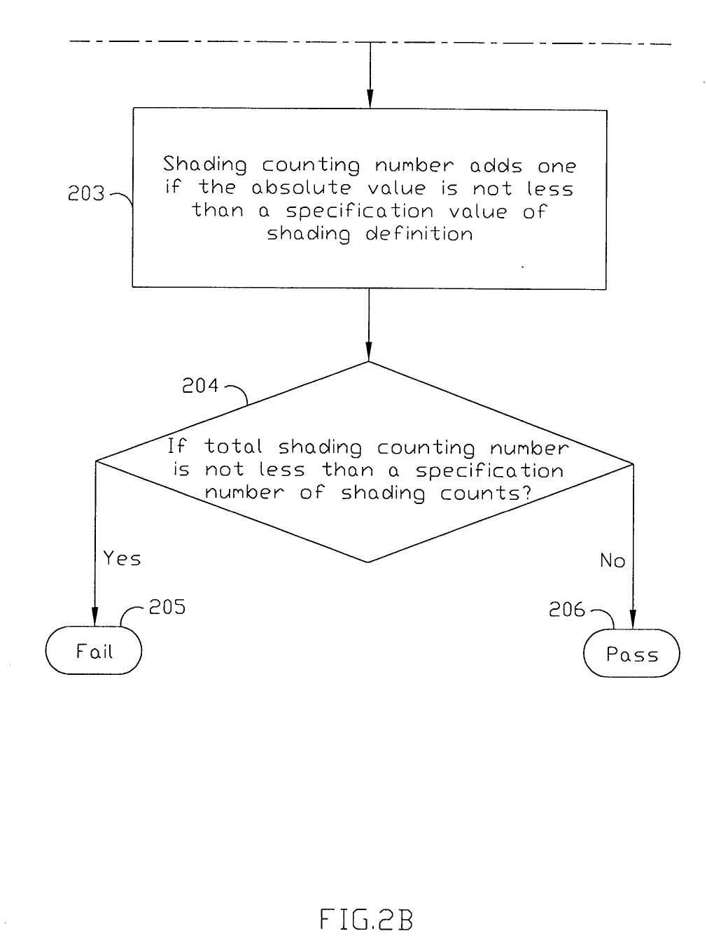

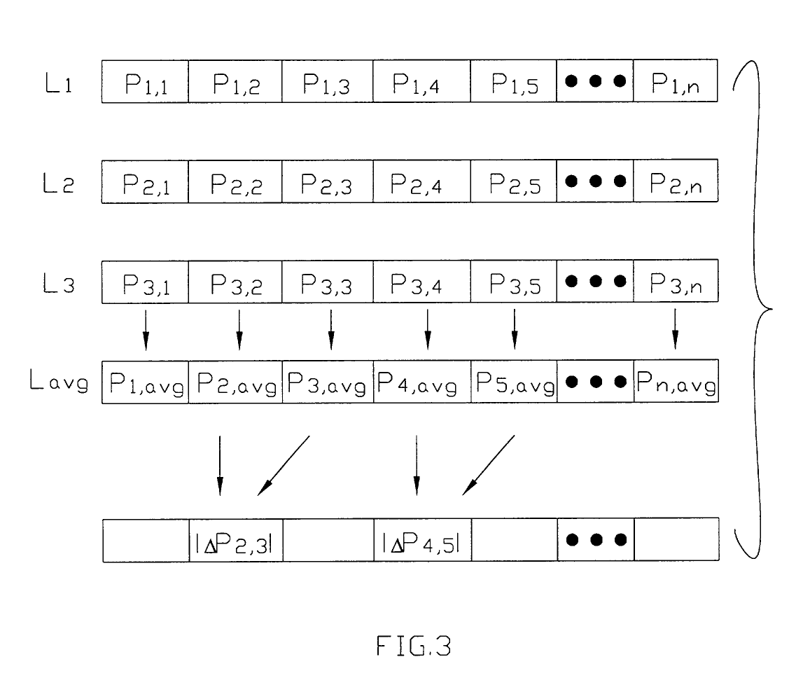

FIGS. 2A and 2B is a flow chart of the present method according to the embodiment. FIG. 3 schematically illustrates steps of selecting a shading correcting line in accordance with the principle of the present invention. Initially, at step 200, scanning a white reference source, such as a white reference plate, to obtain a plurality of scan lines, such as L₁, L₂ and L₃ (see FIG. 3), each of which composed of pixel brightness values (P_{1,1}, P_{1,2}, P_{1,3}, P_{1,4}, P_{1,5} . . . P_{1,n}), (P_{2,1}, P_{2,2}, P_{2,3}, P_{2,4}, P_{2,5} . . . , P_{2,n}), and (P_{3,1}, P_{3,2}, P_{3,3}, P_{3,4}, P_{3,5} . . . , P_{3,n}), respectively. However, the number of the scan lines is not limited to only three, any other number is also acceptable. Then, at step 201, generating a new scan line L_{avg} composed of median brightness values (P_{1,avg}, P_{2,avg}, P_{3,avg}, P_{4,avg}, P_{5,avg} . . . , P_{n,avg}) from the scan lines L₁, L₂ and L₃ (see FIG. 3). Each median brightness value is an average of the pixel brightness values from a common column of the scan lines L₁, L₂ and L₃. For example, P_{2,avg} is an average of the pixels brightness values P_{1,2}, P_{2,2} and P_{3,2}. Subsequently, at step 202, taking an absolute value of a difference of median brightness values between each pair of adjacent pixels in the new scan line L_{avg}, for example, |ΔP_{2, 3}|, |ΔP_{4, 5}| etc (see FIG. 3). At step 203, adding one count in shading counting number when the absolute value is not less than a specification value of shading definition. Then, at step 204, judging if total shading counting number of the new scan line L_{avg} is not less than a specification number of shading counts. If it is yes, the new scan line L_{avg} is abandoned (step 205). If it is not, the new scan line L_{avg} is selected as a shading correcting line. The shading correcting line has good shading correction values. And, after the shading correcting line is established, image data are read, and the read image data are subjected to shading correction on the basis of the shading correction values of the selected shading correcting line.

As to a shading correcting line from black reference data, at step 200 of FIG. 2A, a black reference source is scanned to obtain a plurality of scan lines of pixel brightness values. The black reference source can be provided by way of shading the photoelectric linear sensor 107 with the shading plate 106. Alternately, by turning off the exposure lamp 101 and causing the photoelectric linear sensor 107 to perform a reading operation upon the white reference plate 100. Steps 201, 202, 203, 204, 205 and 206 are then followed so as to obtain a shading correcting line generated from the black reference data.

In another aspect of the present invention, according to the flow chart of FIG. 2A and FIG. 2B, the present invention can calculate exact shading counting number of a captured bright image or dark image, and thereby judging whether the captured bright image or dark image can be used. Thus, the present invention can obtain an image with better quality. Following is a detailed description. Initially, at step 200, a bright image is instead of the white reference source, scanning the bright image to obtain a plurality of scan lines, such as L₁, L₂ and L₃ (see FIG. 3), each of which composed of pixel brightness values (P_{1,1} , P_{1,2}, P_{1,3}, P_{1,4}, P_{1,5}. . . , P_{1,n}), (P_{2,1}, P_{2,2}, P_{2,3}, P_{2,4}, P_{2,5} . . . , P_{2,n}), and (P_{3,1}, P_{3,2}, P_{3,3}, P_{3,4}, P_{3,5} . . . , P_{3,n}), respectively. However, the number of the scan lines is not limited to only three, any other number is also acceptable. Then, at step 201, generating a new scan line L_{avg} composed of median brightness values (P_{1,avg}, P_{2,avg}, P_{3,avg}, P_{4,avg}, P_{5,avg} . . . P_{n,avg}) from the scan lines L₁, L₂ and L₃ (see FIG. 3). Each median brightness value is an average of the pixel brightness values from a common column of the scan lines L₁, L₂ and L₃. For example, P_{2,avg} is an average of the pixels brightness values P_{1,2}, P_{2,2} and P_{3,2}. Subsequently, at step 202, taking an absolute value of a difference of median brightness values between each pair of adjacent pixels in the new scan line L_{avg}, for example, |ΔP_{2, 3}|, |ΔP_{4, 5}| etc (see FIG. 3). At step 203, adding one count in shading counting number when the absolute value is not less than a specification value of shading definition. Then, at step 204, judging if total shading counting number of the new scan line L_{avg} is less than a specification number of shading counts. If it is not, the bright image captured at step 200 is abandoned (step 205). If it is yes, the bright image captured at step 200 is allowable.

As to how to calculate exact shading counting number of a dark image, at step 200, the dark image is instead of the bright image, scanning the dark image to obtain a plurality of scan lines of pixel brightness values. Steps 201, 202, 203, 204, 205 and 206 are then followed. At step 204, judging if total shading counting number of the new scan line L_{avg} is less than a specification number of shading counts. If it is not, the dark image captured at step 200 is abandoned (step 205). If it is yes, the dark image captured at step 200 is allowable.

In accordance with the above described, the present invention makes a shading correction operation based on good shading correction values, thereby being capable of obtaining a good shading-corrected image. It is also possible to enable image reading performed with a high degree of reliability. The adverse effects due to impulse noise or dust that is accumulated on a white reference plate also can be removed.

The embodiments are only used to illustrate the present invention, not intended to limit the scope thereof. Many modifications of the embodiments can be made without departing from the spirit of the present invention.

What is claimed is:

1. A method of selecting a shading correcting line for a bright image, comprising:
scanning a white reference source to obtain a plurality of first scan lines of pixel brightness values;
generating a second scan line composed of median brightness values from said first scan lines, each said median brightness value being an average of said pixel brightness values from a common column of said first scan lines;
adding one count in shading counting number when an absolute value of a difference of said median brightness values between each pair of adjacent pixels in said second scan line being not less than a specification value of shading definition; and
when total shading counting number is less than a specification number of shading counts, selecting said second scan line as a shading correcting line.

2. The method of claim 1, wherein said white reference source comprises a white reference plate.

3. The method of claim 1, wherein said first scan lines are captured by a charge-coupled device.

4. The method of claim 1, wherein said first scan lines are captured by a contact image sensor.

5. A method of selecting a shading correcting line for a dark image, comprising:
scanning a black reference source to obtain a plurality of first scan lines of black reference values;
generating a second scan line composed of median black reference values from said first scan lines, each said median black reference value being an average of said black reference values from a common column of said first scan lines;
adding one count in shading counting number when an absolute value of a difference of said median black reference values between each pair of adjacent pixels in said second scan line being not less than a specification value of shading definition; and
when total shading counting number is less than a specification number of shading counts, selecting said second scan line as a shading correcting line.

6. The method of claim 5, wherein said black reference source comprises a black reference plate.

7. The method of claim 5, wherein said first scan lines are captured by scanning a white reference plate upon turning off a light source.

8. The method of claim 5, wherein said first scan lines are captured by scanning a white reference plate upon using a shading plate to shade a light receiving plane of a photosensitive detector.

9. The method of claim 8, wherein said photosensitive detector comprises a linear charged-coupled device.

10. The method of claim 8, wherein said photosensitive detector comprises a contact image sensor.

11. A method for judging shading of an image, comprising:
scanning an image to obtain a plurality of first scan lines each of which having several pixel values;
generating a second scan line composed of median pixel values from said first scan lines, each said median pixel value being an average of said pixel values from a common column of said first scan lines;
adding one count in shading counting number when an absolute value of a difference of said median pixel values between each pair of adjacent pixels in said second scan line being not less than a specification value of shading definition; and
when total shading counting number is less than a specification number of shading counts, said image is allowable.

12. The method of claim 11, wherein said image comprises a bright image.

13. The method of claim 11, wherein said image comprises a dark image.

14. The method of claim 11, wherein said first scan lines are captured by a charge-coupled device.

15. The method of claim 11, wherein said first scan lines are captured by a contact image sensor.
